(19) United States
(12) Patent Application Publication
(10) Pub. No.: US 2022/0289586 A1
(43) Pub. Date: Sep. 15, 2022

(54) A HYDROGEN-ANNEALED BIMETALLIC OXIDE AND IMPLEMENTATIONS THEREOF

(71) Applicant: INDIAN INSTITUTE OF TECHNOLOGY, JODHPUR, Karwar Jodhpur (IN)

(72) Inventors: Devika LAISHRAM, Karwar Jodhpur (IN); Kiran Prakash SHEJALE, Karwar Jodhpur (IN); Rakesh Kumar SHARMA, Karwar Jodhpur (IN)

(21) Appl. No.: 17/632,280

(22) PCT Filed: Aug. 4, 2020
(86) PCT No.: PCT/IN2020/050688

§ 371 Date: Feb. 2, 2022

(30) Foreign Application Priority Data
Aug. 5, 2019 (IN) 201911031662

(51) Int. Cl. C01F 17/30; B01J 23/83; B01J 37/08; B01J 37/04; F01N 3/10

(52) U.S. Cl. CPC C01F 17/30; B01J 23/83; B01J 37/08; B01J 37/04; F01N 3/103; F01N 2370/02

(57) ABSTRACT

The present disclosure relates a hydrogen-annealed bimetallic oxide of Formula I: AₓO₂—B_{y}O_{z}, wherein the A is a metal selected from Hf, Ti, or Zr; B is a metal selected from Ce, Zn, Fe or Co; x is in the range of 1-2; y is in the range of 1-4; and z is in the range of 1-6. The present disclosure further relates to a convenient process for preparing the hydrogen-annealed bimetallic oxide and a method for catalytically treating an exhaust stream is also disclosed herein.

### FIELD OF INVENTION

The present disclosure relates to the field of catalysis. In particular, it relates to the field catalytic converters present in automobiles.

### BACKGROUND OF THE INVENTION

In light of the global threat posed by environmental pollution, there has been a renewed focus on emissions. Several countries including the European Union, India and the US, have steadily constituted stricter norms of qualification for vehicular emissions, which have posed new challenges to automobile manufacturers.

Catalytic converters are an indispensable part of modern day automobiles, with several countries (including US) prohibiting its removal, except for replacement. The “catalyst” in the converter, which is the workhorse of the equipment, essentially is made up of a multi-metallic composition for tackling a wide variety of pollutants such as NOₓ. Many vehicular systems lack a mechanism for removal of particulate matter (PM), whereby additional “soot-traps” or particulate filters are employed for the reduction in the PM.

U.S. Pat. No. 7,097,817 identifies a wall-flow filter for the exhaust system of combustion engines, comprising a honeycomb arrangement. U.S. Pat. No. 5,501,714 discloses platinum group metals as suitable catalysts for improving combustion in a diesel engine.

A well-known problem with the field is the relatively high temperatures required for ensuring acceptable catalytic conversion. This, leads to the additional requirement of thermal “activation” of catalysts, especially when the engine has been ignited (is “cold”).

Therefore, several research groups have identified multi-metallic nanoparticles for the purpose of particulate matter removal from exhaust (Y. Cheng et al, ACS Catal. 2017, 7, 3883-3892).

Further, the industrial-grade catalysts in this regard are known to contain platinum among other precious metals. Even though many such metals are expensive, the high catalytic efficiency makes their use feasible. Therefore, catalysts providing improved efficiency, especially with regards to the removal of particulates, coupled with low operating temperatures are sought after.

### SUMMARY OF THE INVENTION

In an aspect of the present disclosure, there is provided a hydrogen-annealed bimetallic oxide of Formula I:

AₓO₂—B_{y}O_{z} Formula I

wherein the A is a metal selected from Hf, Ti, or Zr; B is a metal selected from Ce, Zn, Fe or Co; x is in the range of 1-2; y is in the range of 1-4; and z is in the range of 1-6.

In another aspect of the present disclosure, there is provided a process for preparing the hydrogen-annealed bimetallic oxide of Formula I

AₓO₂—B_{y}O_{z} Formula I

wherein the A is a metal selected from Hf, Ti, or Zr; B is a metal selected from Ce, Zn, Fe or Co; x is in the range of 1-2; y is in the range of 1-4; and z is in the range of 1-6, said process comprising: (a) obtaining a first precursor and a second precursor; (b) contacting the first precursor and the second precursor with at least one directing agent in the presence of at least one solvent to form a first mixture; (c) drying the first mixture to obtain a second mixture; (d) thermally treating the second mixture in the presence of at least one solvent and at least one reducing agent to obtain a third mixture; and (e) annealing the third mixture in the presence of hydrogen to obtain the hydrogen-annealed bimetallic oxide.

In another aspect of the present disclosure, there is provided a method for catalytically treating an exhaust stream comprising: i) obtaining a hydrogen-annealed bimetallic oxide of Formula I

AₓO₂—B_{y}O_{z} Formula I

wherein the A is a metal selected from Hf, Ti, or Zr; B is a metal selected from Ce, Zn, Fe or Co; x is in the range of 1-2; y is in the range of 1-4; and z is in the range of 1-6; and ii) treating an exhaust stream with the hydrogen-annealed bimetallic oxide to obtain a treated stream.

In another aspect of the present disclosure, there is provided a use of the hydrogen-annealed bimetallic oxide of Formula I

AₓO₂—B_{y}O_{z} Formula I

wherein the A is a metal selected from Hf, Ti, or Zr; B is a metal selected from Ce, Zn, Fe or Co; x is in the range of 1-2; y is in the range of 1-4; and z is in the range of 1-6 for catalytically treating an exhaust stream.

These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF THE ACCOMPANYING FIGURES

In order that the disclosure may be readily understood and put into practical effect, reference will now be made to exemplary embodiments as illustrated with reference to the accompanying figures. The figures together with a detailed description below, are incorporated in and form part of the specification, and serve to further illustrate the embodiments and explain various principles and advantages, in accordance with the present disclosure wherein:

FIGS. 1(a) and 1(b) illustrate transmission electron microscopic images of the air-annealed and hydrogen-annealed bimetallic oxide, in accordance with an implementation of the present disclosure.

FIGS. 2(a-c) illustrate the thermal gravimetric analysis of the oxides, in accordance with an implementation of the present disclosure.

FIG. 3 illustrates the thermal gravimetric analysis of the hydrogen-annealed bimetallic oxide, in accordance with an implementation of the present disclosure.

FIG. 4 illustrates a schematic representation of the catalytic treatment of an exhaust stream, in accordance with an implementation of the present disclosure.

### DETAILED DESCRIPTION OF THE INVENTION

Those skilled in the art will be aware that the present disclosure is subject to variations and modifications other than those specifically described. It is to be understood that the present disclosure includes all such variations and modifications. The disclosure also includes all such steps, features, compositions, and compounds referred to or indicated in this specification, individually or collectively, and any and all combinations of any or more of such steps or features.

### Definitions

For convenience, before further description of the present disclosure, certain terms employed in the specification, and examples are collected here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a concentration range of about 450-550° C. should be interpreted to include not only the explicitly recited limits of about 450° C. to about 550° C., but also to include sub-ranges, such as 470° C., 490° C., 540° C., and so forth, as well as individual amounts, including fractional amounts, within the specified ranges, such as 460.5° C., and 540.7° C., for example.

The term “soot” is used to refer to a mass of amorphous carbon particles resulting from the incomplete combustion of hydrocarbons. Soot is a particulate pollutant, known to cause various types of cancer and lung disease. Therefore, catalysts that are able to successfully convert soot are sought after.

The term “exhaust stream” is used to refer to gases and/or particulate (such as soot) emitted via combustion of hydrocarbons from engines including, but not limited to, internal combustion engines. The hydrogen-annealed bimetallic oxide catalyzes the oxidation of soot particles present in the exhaust stream.

The term “hydrogen-annealed” is used to refer to annealing under a hydrogen atmosphere. Herein, the hydrogen atmosphere may be provided by ensuring a positive partial pressure of hydrogen gas. The treatment is found to render surprising properties such as enhanced porosity to the thus formed oxide.

Hafnium oxide is employed as part of the hydrogen-annealed bimetallic oxide in minute quantities as a dopant. The present disclosure does not envisage any radioactive use of hafnium.

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the disclosure, the preferred methods, and materials are now described. All publications mentioned herein are incorporated herein by reference.

The present disclosure is not to be limited in scope by the specific implementations described herein, which are intended for the purposes of exemplification only. Functionally-equivalent products, compositions, and methods are clearly within the scope of the disclosure, as described herein.

Incomplete combustion in the diesel engines leads to huge emissions of atmospheric pollutants as soot particulates and toxic gases. Soot emission is a significant component of air pollution and is harmful for both human beings and the environment. Among several techniques that have been developed for reducing the emissions from diesel engines, filtering followed by catalytic oxidation is one of the most promising options. This is based on the application of a catalyst to achieve the onset of regeneration at a significantly lower temperature. Typically catalysts employed for soot oxidation should decrease the oxidation temperature and maintain a high activity for longer working periods. Hence there is a dire need for catalysts that are able to provide suitably high catalytic efficiency while operating at relatively low temperatures. In this regard, the present disclosure provides a hydrogen-annealed bimetallic oxide, that is effective in catalyzing the oxidation of soot present in an exhaust stream at a temperature range of 30 to 900° C.

In an embodiment of the present disclosure, there is provided a hydrogen-annealed bimetallic oxide of Formula I:

AₓO₂—B_{y}O_{z} Formula I

wherein the A is a metal selected from Hf, Ti, or Zr; B is a metal selected from Ce, Zn, Fe or Co; x is in the range of 1-2; y is in the range of 1-4; and z is in the range of 1-6. In an embodiment of the present disclosure, AₓO₂ is not covalently bonded to B_{y}O_{z}.

In an embodiment of the present disclosure, there is provided a hydrogen-annealed bimetallic oxide of Formula I as described herein, wherein the x is 1; y is in the range of 1-3; and z is in the range of 2-6. In another embodiment of the present disclosure, there is provided a hydrogen-annealed bimetallic oxide of Formula I as described herein, wherein the x is 1; y is 1; and z is 2.

In an embodiment of the present disclosure, there is provided a hydrogen-annealed bimetallic oxide of Formula I:

AₓO₂—B_{y}O_{z} Formula I

wherein the A is a metal selected from Hf, Ti, or Zr; B is a metal selected from Ce, Zn, Fe or Co; x is in the range of 1-2; y is in the range of 1-4; and z is in the range of 1-6. In an embodiment of the present disclosure, there is provided a hydrogen-annealed bimetallic oxide, wherein the A is Hf; B is Ce; x is 1; y is 1; and z is 2.

In an embodiment of the present disclosure, there is provided a hydrogen-annealed bimetallic oxide of Formula I as described herein, wherein the AₓO₂ to B_{y}O_{z} weight ratio is in the range of 1:4 to 4:1. In another embodiment of the present disclosure, the AₓO₂ to B_{y}O_{z} weight ratio is 2:1. In one another embodiment of the present disclosure, the AₓO₂ to B_{y}O_{z} weight ratio is 1:1.

In an embodiment of the present disclosure, there is provided a process for preparing the hydrogen-annealed bimetallic oxide of Formula I

AₓO₂—B_{y}O_{z} Formula I

wherein the A is a metal selected from Hf, Ti, or Zr; B is a metal selected from Ce, Zn, Fe or Co; x is in the range of 1-2; y is in the range of 1-4; and z is in the range of 1-6, said process comprising: (a) obtaining a first precursor and a second precursor; (b) contacting the first precursor and the second precursor with at least one directing agent in the presence of at least one solvent to form a first mixture; (c) drying the first mixture to obtain a second mixture; and (d) thermally treating the second mixture in the presence of at least one solvent and at least one reducing agent to obtain a third mixture; (e) annealing the third mixture in the presence of hydrogen to obtain the hydrogen-annealed bimetallic oxide.

In an embodiment of the present disclosure, there is provided a process for preparing the hydrogen-annealed bimetallic oxide as described herein, wherein the first precursor is selected from the group consisting of Hafnium isopropoxide, Titanium tetraisopropoxide, Zirconium isopropoxide and combinations thereof. In another embodiment of the present disclosure, the first precursor is Hafnium isopropoxide.

In an embodiment of the present disclosure, there is provided a process for preparing the hydrogen-annealed bimetallic oxide as described herein, wherein the second precursor is selected from the group consisting of cerium nitrate hexahydrate, zinc nitrate hexahydrate, ferrous sulphate, cobalt nitrate hexahydrate and combinations thereof. In another embodiment of the present disclosure, the second precursor is cerium nitrate hexahydrate.

In an embodiment of the present disclosure, there is provided a process for preparing the hydrogen-annealed bimetallic oxide as described herein, wherein the at least one solvent is ethanol, methanol or combinations thereof. In another embodiment of the present disclosure, wherein the at least one solvent is ethanol.

In an embodiment of the present disclosure, there is provided a process for preparing the hydrogen-annealed bimetallic oxide as described herein, wherein the at least one directing agent is hexadecylamine, cetyltrimethylammonium bromide (CTAB) or combinations thereof. In another embodiment of the present disclosure, wherein the at least one directing agent is hexadecylamine.

In an embodiment of the present disclosure, there is provided a process for preparing the hydrogen-annealed bimetallic oxide as described herein, wherein the at least one reducing agent is ammonia. In another embodiment of the present disclosure, the at least one reducing agent is liquor ammonia.

In an embodiment of the present disclosure, there is provided a process for preparing the hydrogen-annealed bimetallic oxide as described herein, wherein contacting the first and second precursor with at least one directing agent in the presence of at least one solvent is carried out at a temperature in the range of 20−28° C. for a period in the range of 10-16 hours. In another embodiment of the present disclosure, the contacting the first and second precursor with at least one directing agent in the presence of at least one solvent is carried out at a temperature in the range of 22-26° C. for a period in the range of 11-15 hours. In another embodiment of the present disclosure, the first mixture may be vacuum filtered prior to drying.

In an embodiment of the present disclosure, there is provided a process for preparing the hydrogen-annealed bimetallic oxide as described herein, wherein drying the first mixture is carried out at a temperature in the range of 50-100° C. for a period in the range of 10-16 hours. In another embodiment of the present disclosure, drying the first mixture is carried out at a temperature in the range of 55-95° C. for a period in the range of 11-15 hours. In another embodiment of the present disclosure, the drying may be carried out in an oven.

In an embodiment of the present disclosure, there is provided a process for preparing the hydrogen-annealed bimetallic oxide as described herein, wherein thermally treating the second mixture in the presence of at least one solvent and at least one reducing agent is carried out at a temperature in the range of 140-180° C. for a period in the range of 6-10 hours. In another embodiment of the present disclosure, there is provided a process for preparing the hydrogen-annealed bimetallic oxide as described herein, wherein thermally treating the second mixture in the presence of at least one solvent and at least one reducing agent is carried out at a temperature in the range of 150-170° C. for a period in the range of 7-9 hours.

In an embodiment of the present disclosure, there is provided a process for preparing the hydrogen-annealed bimetallic oxide as described herein, wherein annealing the third mixture is carried out at a temperature in the range of 450-550° C. for a period in the range of 1-3 hours. In another embodiment of the present disclosure, annealing the third mixture is carried out at a temperature in the range of 480-530° C. for a period in the range of 1.5-2.5 hours. In another embodiment of the present disclosure, annealing the third mixture is carried out at a temperature of 500° C. for a period of 2.0 hours.

In an embodiment of the present disclosure, there is provided a process for preparing the hydrogen-annealed bimetallic oxide as described herein, wherein annealing the third mixture in the presence of hydrogen having a pressure of 2-8 psi. In another embodiment of the present disclosure, the hydrogen has a pressure in the range of 3-7 psi.

In an embodiment of the present disclosure, there is provided a process for preparing the hydrogen-annealed bimetallic oxide the process comprising (a) obtaining a first precursor selected from the group consisting of Hafnium isopropoxide, Titanium tetraisopropoxide, Zirconium isopropoxide and combinations thereof and the second precursor selected from the group consisting of cerium nitrate hexahydrate, zinc nitrate hexahydrate, ferrous sulphate, cobalt nitrate hexahydrate and combinations thereof; (b) contacting the first precursor and the second precursor with at least one directing agent in the presence of at least one solvent at a temperature in the range of 20-28° C. for a period in the range of 10-16 hours to form a first mixture; (c) drying the first mixture at a temperature in the range of 50-100° C. for a period in the range of 10-16 hours to obtain a second mixture; (d) thermally treating the second mixture in the presence of at least one solvent and at least one reducing agent is carried out at a temperature in the range of 140-180° C. for a period in the range of 6-10 hours to obtain a third mixture; and (e) annealing the third mixture in the presence of hydrogen at a temperature in the range of 450-550° C. for a period in the range of 1-3 hour to obtain the hydrogen-annealed bimetallic oxide.

In an embodiment of the present disclosure, there is provided a method for catalytically treating an exhaust stream comprising: i) obtaining a hydrogen-annealed bimetallic oxide of Formula I

AₓO₂—B_{y}O_{z} Formula I

wherein the A is a metal selected from Hf, Ti, or Zr; B is a metal selected from Ce, Zn, Fe or Co; x is in the range of 1-2; y is in the range of 1-4; and z is in the range of 1-6; and ii) treating an exhaust stream with the hydrogen-annealed bimetallic oxide to obtain a treated stream.

In an embodiment of the present disclosure, there is provided a method for catalytically treating an exhaust stream comprising: i) obtaining a hydrogen-annealed bimetallic oxide of Formula I

AₓO₂—B_{y}O_{z} Formula I

wherein the A is a metal selected from Hf, Ti, or Zr; B is a metal selected from Ce, Zn, Fe or Co; x is in the range of 1-2; y is in the range of 1-4; and z is in the range of 1-6 by a process comprising: (a) obtaining a first precursor and second precursor; (b) contacting the first precursor and the second precursor with at least one directing agent in the presence of at least one solvent to form a first mixture; (c) drying the first mixture to obtain a second mixture; (d) thermally treating the second mixture in the presence of at least one solvent and at least one reducing agent to obtain a third mixture; and (e) annealing the third mixture in the presence of hydrogen to obtain the hydrogen-annealed bimetallic oxide; and ii) treating an exhaust stream with the hydrogen-annealed bimetallic oxide to obtain a treated stream.

In an embodiment of the present disclosure, there is provided a method for catalytically treating an exhaust stream as described herein, wherein treating the exhaust stream is carried out at a temperature in the range of 30-900° C. In another embodiment of the present disclosure, treating the exhaust stream is carried out at a temperature in the range of 350-850° C.

In an embodiment of the present disclosure, there is provided a method for catalytically treating an exhaust stream as described herein, wherein treating the exhaust stream is carried out in the presence of oxygen.

In an embodiment of the present disclosure, there is provided a hydrogen-annealed bimetallic oxide of Formula I as described herein for use in automobiles, industries, and factories. In another embodiment of the present disclosure, the hydrogen-annealed bimetallic oxide is usable as part of particulate filters in diesel automobiles.

In an embodiment of the present disclosure, there is provided use of hydrogen-annealed bimetallic oxide of Formula I as described herein for catalytically treating an exhaust stream. In another embodiment of the present disclosure, there is provided use of hydrogen-annealed bimetallic oxide of Formula I as described herein for catalytic soot oxidation of an exhaust stream.

### EXAMPLES

The disclosure will now be illustrated with working examples, which is intended to illustrate the working of disclosure and not intended to take restrictively to imply any limitations on the scope of the present disclosure. Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein. It is to be understood that this disclosure is not limited to particular methods, and experimental conditions described, as such methods and conditions may apply.

The present disclosure provides a hydrogen-annealed bimetallic oxide of Formula I:

AₓO₂—B_{y}O_{z} Formula I

wherein the A is a metal selected from Hf, Ti, or Zr; B is a metal selected from Ce, Zn, Fe or Co; x is in the range of 1-2; y is in the range of 1-4; and z is in the range of 1-6 in greater detail. Said oxide is noted to have a weight ratio of AₓO₂ to B_{y}O_{z} in the range of 1:4 to 4:1. The hydrogen-annealed bimetallic oxide was found to have higher catalytic activity in the soot oxidation at a much lower operating temperatures. The hydrogen-annealed bimetallic oxide had an increased porosity which facilitated the catalytic oxidation of CO and soot. The process of preparation of the hydrogen-annealed bimetallic oxide is also disclosed herein. A convenient method for catalytically treating the exhaust stream was achieved by treating the exhaust stream with the hydrogen-annealed bimetallic oxide of the present disclosure in the presence of oxygen.

### Materials and Methods

Hafnium isopropoxide and cerium nitrate hexahydrate were procured from Alfa Aesar. All the chemicals were obtained from high grade certified reagent houses and were used without further purification.

The hydrogen-annealed bimetallic oxide of the present disclosure, as synthesized in Example 1, were characterized by transmission electron microscopy (TEM) measurements were done on a FEI Tecnai-G2 T20 transmission electron microscope.

### Example 1

Process of preparing the hydrogen-annealed bimetallic oxide (HfO₂—CeO₂)

A series of hydrogen-annealed bimetallic oxides were prepared by solid-state reaction method. All used reagents were highly purity AR grade and used without further purification.

The hydrogen-annealed bimetallic oxide of Formula I HfO₂—CeO₂ is prepared by the process defined below. The first precursor, i.e., Hafnium isopropoxide and the second precursor, i.e., cerium nitrate hexahydrate was mixed in the weight ratio of 1:1 in the presence of at least one directing agent and at least one solvent. 33 mM of Hafnium isopropoxide and cerium nitrate hexahydrate were mixed in 200 ml of ethanol (at least one solvent). To ethanolic solution containing the precursors 1.975 g of hexadecyl amine (at least one directing agent) was added at a temperature 20-28° C. for a period in the range of 10 to 16 hours and the first mixture was obtained. The structure directing agent (at least one directing agent) helps in providing a particular spherical nano morphology consisting of smaller granular HfO₂ and CeO₂. The first mixture was vacuum filtered and then dried in an oven at a temperature 70° C. for a period of 12 hours to obtain the second mixture. This second mixture was hydrothermally heated at a at a temperature of 160° C. for a period of 8 hours in the presence of ethanol (at least one solvent) and ammonia (at least one reducing agent) to result in the third mixture. The prepared third mixture was annealed under hydrogen atmosphere (5 psi of hydrogen) at a temperature of 500° C. for 2 hours and the hydrogen-annealed bimetallic oxide HfO₂—CeO₂ (1:1) was thus prepared.

In another example, the hydrogen-annealed bimetallic oxide HfO₂—CeO₂ (2:1) was prepared by the process defined above and by varying the weight ratios of first precursor and the second precursor as 2:1. These hydrogen-annealed bimetallic oxides HfO₂—CeO₂ (1:1) and HfO₂—CeO₂ (2:1) were then used for catalytic treatment of exhaust stream.

The above-mentioned process was modified to include alternative precursors. The first precursor is a dopant and was selected from Hafnium isopropoxide, Titanium tetraisopropoxide, or Zirconium isopropoxide. The second precursor was selected from cerium nitrate hexahydrate, zinc nitrate hexahydrate, ferrous sulphate or cobalt nitrate hexahydrate.

For a comparative study, monometallic oxides for example air-annealed HfO₂ and hydrogen-annealed HfO₂ were prepared as per the process earlier defined (ACS Sustainable Chem. Eng. 2018, 6, 9, 11286-11294) and were further used.

Air-annealed bimetallic oxide of HfO₂—CeO₂ (1:1) was also prepared by a similar process explained above, except for the annealing was conducted in the presence of air at a temperature of 500° C. for a period of 2 hours. This air-annealed bimetallic oxide was then characterized and compared with the hydrogen-annealed bimetallic oxide.

### Example 2

Characterization of the Hydrogen-Annealed Bimetallic Oxide (HfO₂—CeO₂)

HfO₂—CeO₂ (1:1) obtained from Example 1 was characterized using TEM (refer FIG. 1). FIG. 1(a) on the left reveals air-annealed bimetallic-oxide HfO₂—CeO₂ (1:1) and FIG. 1(b) on the right reveals hydrogen-annealed bimetallic-oxide HfO₂—CeO₂ (1:1). The Figures have been magnified to scale (20 nm) for ease of comparison. The Figures indicate the change in the porosity between the hydrogen-annealed and air-annealed oxides. As can be seen in the encircled areas the granules making up the spheres are seemingly loosened by increasing the porosity, thereby leading to better contact between the soot and catalyst (oxide) during catalysis.

### Example 3

Method for Catalytically Treating an Exhaust Stream Employing the Hydrogen-Annealed Bimetallic Oxide (HfO₂—CeO₂)

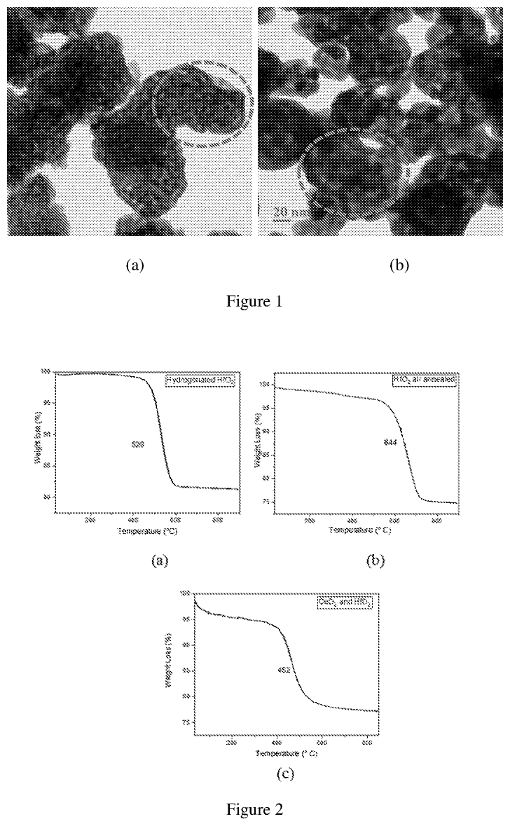

The catalytic treatment of an exhaust stream in the presence of the hydrogen-annealed bimetallic oxide is explained herein. The hydrogen-annealed bimetallic oxide catalyzes the oxidation of the exhaust stream i.e. catalyzes the soot oxidation. The catalytic activity of the HfO₂—CeO₂ was studied by mixing soot and the bimetallic oxide in the weight ratio of 1:4. The mixture was subjected to thermal gravimetric analysis (TGA) (refer FIG. 2) by heating at a temperature 35° C. to 900° C. under zero air and at an air flow rate of 20 mL/min. The T50 (temperature to reduce 50% by weight of soot) was determined. The soot gets oxidized in the presence of air/oxygen catalyzed by the bimetallic oxide.

FIG. 2(a) represent the TGA curve of the air-annealed hafnium oxide (air annealed HfO₂), FIG. 2(b) represent the TGA curve of the hydrogen-annealed hafnium oxide (hydrogenated HfO₂) and FIG. 2(c) illustrate the TGA curve of the hydrogen-annealed bimetallic oxide HfO₂:CeO₂ (1:1) from example 1.

The effect of hydrogen annealing in the oxide was established on hafnium oxide (HfO₂). Herein, it was noted that hydrogen annealing led to a remarkable decrease in T50 from 644 to 529° C. The soot oxidation catalyzed by air-annealed HfO₂ had a higher T50 when compared to that of hydrogen-annealed hafnium oxide. This was because of better interaction of the catalyst and soot due to pore enlargement (as shown in FIG. 1).

The hydrogen-annealed bimetallic oxide HfO₂:CeO₂ (1:1) was found to reveal a lowered T50 at 452° C. (FIG. 2(c)). Hydrogen-annealed bimetallic oxide HfO₂:CeO₂ (1:1) oxidized the soot at a lower temperature when compared to the other oxides. This lowering of T50 depend on the contact between soot and catalyst and also on the specific area of the catalyst. The nanomorphology of the catalyst achieved via the structure directing agent in the preparation process ensured a higher specific area. However there occurs growth of oxide particles during soot oxidation which would decrease its catalytic activity. But the growth become detrimental when the pores increased in the oxide, which in turn increased the catalytic activity. The hydrogen-annealing of the bimetallic oxide exhibiting enhanced porosity favoured its catalytic efficiency thereby lowering the T50.

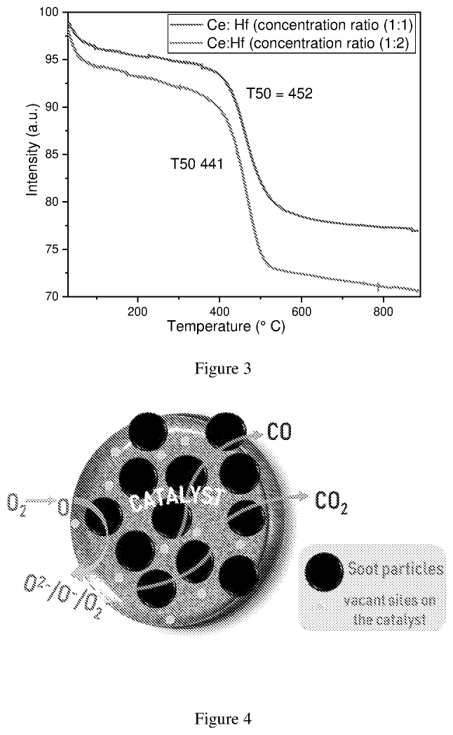

FIG. 3 illustrates the TGA curve of soot oxidation catalyzed by hydrogen-annealed bimetallic oxide HfO₂:CeO₂ (1:1) and hydrogen-annealed bimetallic oxide HfO₂:CeO₂ (2:1) from example 1. HfO₂:CeO₂ (2:1) was found to have a surprisingly, much lower T50 of 441° C. The lowering of T50 by varying the weight ratio was because increase in HfO₂ enhanced incorporation of Hf⁴⁺ ions into the CeO₂ lattice. This created vacant sites/pores in the oxide which further increased its catalytic efficiency in soot oxidation. Thus, hydrogen-annealed bimetallic oxide was found to exhibit enhanced porosity and an increase in oxygen vacant sites brought about by the hierarchical morphological nanospherical structure along with the hydrogenation (hydrogen annealing).

FIG. 4 illustrates a schematic representation of the catalytic treatment of an exhaust stream. Hence, the hydrogen-annealed bimetallic oxide of the present disclosure with an enhanced porosity in comparison to the air-annealed bimetallic oxide was found to be an appropriate catalyst in the treatment of the exhaust stream.

### ADVANTAGES OF THE PRESENT DISCLOSURE

The present disclosure provides a hydrogen-annealed bimetallic oxide of Formula I:

AₓO₂—B_{y}O_{z} Formula I

wherein the A is a metal selected from Hf, Ti, or Zr; B is a metal selected from Ce, Zn, Fe or Co; x is in the range of 1-2; y is in the range of 1-4; and z is in the range of 1-6. The hydrogen-annealed bimetallic oxides reveal impressively low operating temperatures. The hydrogen-annealed bimetallic oxides of the present disclosure have an enhanced porosity which aid the oxides to be suitably used as a catalyst. The hydrogen-annealed bimetallic oxides are employable as catalyst for use in catalytic converter of Diesel Particulate Filters (DPF) in diesel-based engines. The hydrogen-annealed bimetallic oxides lower the T50 of the soot oxidation significantly. The oxides increase the life of the catalytic converter and filters while reducing the emission of soot from the exhaust of diesel engines.

1. A hydrogen-annealed bimetallic oxide of Formula I:
AₓO₂—B_{y}O_{z} Formula I
wherein the A is a metal selected from Hf, Ti, or Zr; B is a metal selected from Ce, Zn, Fe or Co; x is in the range of 1-2; y is in the range of 1-4; and z is in the range of 1-6.

2. The hydrogen-annealed bimetallic oxide as claimed in claim 1, wherein the x is 1; y is in the range of 1-3; and z is in the range of 2-6.

3. The hydrogen-annealed bimetallic oxide as claimed in claim 1, wherein the AₓO₂ to B_{y}O_{z} weight ratio is in the range of 1:4 to 4:1.

4. A process for preparing the hydrogen-annealed bimetallic oxide as claimed in claim 1, said process comprising:
a) obtaining a first precursor and a second precursor;
b) contacting the first precursor and the second precursor with at least one directing agent in the presence of at least one solvent to form a first mixture;
c) drying the first mixture to obtain a second mixture;
d) thermally treating the second mixture in the presence of at least one solvent and at least one reducing agent to obtain a third mixture; and
e) annealing the third mixture in the presence of hydrogen to obtain the hydrogen-annealed bimetallic oxide.

5. The process for preparing the hydrogen-annealed bimetallic oxide as claimed in claim 4, wherein the first precursor is selected from the group consisting of Hafnium isopropoxide, Titanium tetraisopropoxide, Zirconium isopropoxide and combinations thereof and the second precursor is selected from the group consisting of cerium nitrate hexahydrate, zinc nitrate hexahydrate, ferrous sulphate, cobalt nitrate hexahydrate and combinations thereof.

6. The process for preparing the hydrogen-annealed bimetallic oxide as claimed in claim 4, wherein the at least one solvent is selected from ethanol, methanol or combinations thereof, the at least one directing agent is hexadecylamine, cetyltrimethylammonium bromide (CTAB) or combinations thereof and the at least one reducing agent is ammonia.

7. The process for preparing the hydrogen-annealed bimetallic oxide as claimed in claim 4, wherein contacting the first and second precursor with at least one directing agent in the presence of at least one solvent is carried out at a temperature in the range of 20-28° C. for a period in the range of 10-16 hours, drying the first mixture is carried out at a temperature in the range of 50-100° C. for a period in the range of 10-16 hours, thermally treating the second mixture in the presence of at least one solvent and at least one reducing agent is carried out at a temperature in the range of 140-180° C. for a period in the range of 6-10 hours, annealing the third mixture is carried out in at a temperature in the range of 450-550° C. for a period in the range of 1-3 hours.

8. The process for preparing the hydrogen-annealed bimetallic oxide as claimed in claim 4, wherein annealing the third mixture in the presence of hydrogen having a pressure of 2-8 psi.

9. A method for catalytically treating an exhaust stream comprising:
a) obtaining a hydrogen-annealed bimetallic oxide as claimed in the claim 1; and
b) treating an exhaust stream with the hydrogen-annealed bimetallic oxide to obtain a treated stream.

10. The method for catalytically treating an exhaust stream as claimed in claim 9, wherein treating the exhaust stream is carried out at a temperature in the range of 30-900° C.

11. The method for catalytically treating an exhaust stream as claimed in claim 9, wherein treating the exhaust stream is carried out in the presence of oxygen.

12. The hydrogen-annealed bimetallic oxide as claimed in claim 1 for use in automobiles, industries and factories.

13. Use of hydrogen-annealed bimetallic oxide as claimed in claim 1 for catalytically treating an exhaust stream.
